(19) United States
(12) Patent Application Publication
(10) Pub. No.: US 2026/0140870 A1
(43) Pub. Date: May 21, 2026

(54) ZUFS MEMORY SYSTEMS, METHODS OF OPERATING, AND SYSTEMS

(71) Applicant: YANGTZE MEMORY TECHNOLOGIES CO., LTD., Wuhan (CN)

(72) Inventors: Hao HE, Wuhan (CN); Haochiang HSU, Wuhan (CN); Zhuangfei QIAN, Wuhan (CN); Hua TAN, Wuhan (CN)

(21) Appl. No.: 19/184,558

(22) Filed: Apr. 21, 2025

(30) Foreign Application Priority Data
Nov. 19, 2024 (CN) 2024116594821

(51) Int. Cl. G06F 12/02

(52) U.S. Cl. CPC G06F 12/0246

(57) ABSTRACT

A ZUFS memory system includes: a memory device; and a memory controller coupled with the memory device and configured to control the memory device to perform partition storage by zones, wherein a storage space of a zone is configured to support sequential writing; wherein the memory controller is configured with a first interface for coupling with a host, and receives a first command from the host through the first interface, the first command comprises specified mode information, and the specified mode information indicates a storage mode of a to-be-created zone; and the memory controller is further configured to: determine whether available storage space of the memory device satisfies a creation condition according to the specified mode information; and create the zone with the storage mode according to the first command in response to the available storage space satisfying the creation condition.

### CROSS-REFERENCE TO RELATED APPLICATIONS

The present disclosure claims priority to Chinese Patent Application No. 2024116594821, which was filed Nov. 19, 2024, and is hereby incorporated herein by reference in its entirety.

### TECHNICAL FIELD

Examples of the present disclosure relate to the field of semiconductor technology, and in particular to a ZUFS memory system and a method of operating, a system and a storage medium thereof.

### BACKGROUND

A memory system may include one or more memories that store data. The memory system may be a memory system that supports zoned namespace (ZNS).

### SUMMARY

The examples of the present disclosure provide a memory system and a method of operating, a system and a storage medium thereof.

According to a first aspect, the examples of the present disclosure provide a zoned universal flash storage (ZUFS) memory system, comprising: a memory device; and a memory controller coupled with the memory device, the memory controller is configured to control the memory device to perform partition storage by zones, wherein a storage space of a zone is configured to support sequential writing; wherein the memory controller is configured with a first interface for coupling with a host, and receives a first command from the host through the first interface, the first command comprises specified mode information, and the specified mode information indicates a storage mode of a to-be-created zone; and the memory controller is further configured to: determine whether available storage space of the memory device satisfies a creation condition according to the specified mode information; and in response to the available storage space satisfying the creation condition, create the zone with the storage mode according to the first command.

In the above solution, the memory controller is configured to: set a state of the created zone to an open state, and send creation success information to the host through the first interface.

In the above solution, the memory controller is configured to: in response to the available storage space not satisfying the creation condition, send creation failure information to the host through the first interface.

In the above solution, the creation condition comprises that the available storage space of the memory device is greater than a storage space occupied by the to-be-created zone.

In the above solution, the memory controller is further configured to: receive a zone writing request and writing data through the first interface, and write the writing data into the created zone according to the zone writing request.

In the above solution, the storage mode comprises a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

In the above solution, the memory controller is further configured to: receive the zone writing request and the writing data through the first interface, wherein if the writing data is hot data, the storage mode is the first storage mode, and if the writing data is non-hot data, the storage mode is the second storage mode; and write the writing data into the zone created according to the first command according to the zone writing request.

In the above solution, the first command comprises an open zone command, and the specified mode information occupies a field of seven bits in the open zone command.

In the above solution, the zone is a zone in a zone namespace (ZNS).

According to a second aspect, the examples of the present disclosure provide a system, comprising: a ZUFS memory system and a host; wherein the memory system comprises: a memory device and a memory controller coupled with the memory device and the memory controller is configured to control the memory device to perform partition storage by zones, wherein a storage space of a zone is configured to support sequential writing; the host comprises a host controller and a second interface, wherein the host controller is configured to generate a first command and send the first command to the memory controller through the second interface, wherein the first command comprises specified mode information for indicating a storage mode of a to-be-created zone; and the memory controller is configured with a first interface for coupling with the second interface, and receive a first command from the host through the first interface; determine whether available storage space of the memory device satisfies a creation condition according to the specified mode information; and create a zone with the storage mode according to the first command in response to the available storage space satisfying the creation condition.

In the above solution, the memory controller is configured to: set a state of the created zone to an open state, and send creation success information to the host through the first interface.

In the above solution, the memory controller is configured to: send creation failure information to the host through the first interface in response to the available storage space not satisfying the creation condition.

In the above solution, the creation condition comprises that the available storage space of the memory device is greater than a storage space occupied by the to-be-created zone.

In the above solution, the storage mode comprises a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

In the above solution, the host controller is configured to: generate a corresponding first command according to a cold-hot attribute of writing data; if the writing data is hot data, the storage mode in the first command is the first storage mode, and if the writing data is non-hot data, the storage mode in the first command is the second storage mode.

In the above solution, the host controller is configured to: generate a zone writing request corresponding to the writing data, and send the writing data and the zone writing request to the memory controller through the second interface; and the memory controller is further configured to: receive the zone writing request and the writing data through the first interface, and write the writing data into the zone created according to the first command according to the zone writing request.

In the above solution, the first command comprises an open zone command, and the specified mode information occupies a field of seven bits in the open zone command.

In the above solution, the zone is a zone in a zone namespace (ZNS).

According to a third aspect, the examples of the present disclosure provide a method of operating of a ZUFS memory system, wherein the memory system comprises a memory device and a memory controller coupled with the memory device and the memory controller is configured with a first interface for coupling with a host, and the method comprises: receiving a first command through the first interface, wherein the first command comprises specified mode information for indicating a storage mode of a to-be-created zone; the zone corresponds to a storage space of the memory device, and the storage space of the zone is configured to support sequential writing; determining whether available storage space of the memory device satisfies a creation condition according to the specified mode information; and in response to the available storage space satisfying the creation condition, creating the zone with the storage mode according to the first command.

In the above solution, the method further comprises: setting a state of the created zone to an open state, and sending creation success information to the host through the first interface.

In the above solution, the method further comprises: in response to the available storage space not satisfying the creation condition, sending creation failure information to the host through the first interface.

In the above solution, the creation condition comprises that the available storage space of the memory device is greater than a storage space occupied by the to-be-created zone.

In the above solution, the storage mode comprises a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

In the above solution, the method further comprises: receiving the zone writing request and the writing data through the first interface, wherein if the writing data is hot data, the storage mode is the first storage mode, and if the writing data is non-hot data, the storage mode is the second storage mode; and writing the writing data into the zone created according to the first command according to the zone writing request.

In the above solution, the first command comprises an open zone command, and the specified mode information occupies a field of seven bits in the open zone command.

In the above solution, the zone is a zone in a zone namespace (ZNS).

According to a fourth aspect, the examples of the present disclosure provide a computer-readable storage medium storing a computer program thereon, the computer program, when executed, implements the method of any one of the third aspect.

### BRIEF DESCRIPTION OF THE DRAWINGS

FIG. 1 is a schematic diagram of an example system with a memory system according to an example of the present disclosure.

FIG. 2A is a schematic diagram of an example memory card with a memory system according to an example of the present disclosure.

FIG. 2B is a schematic diagram of an example solid state drive with a memory system according to an example of the present disclosure.

FIG. 3A is a schematic diagram of distribution of memory cells of a 3D NAND type memory according to an example of the present disclosure.

FIG. 3B is a schematic diagram of an example memory device comprising a peripheral circuit according to an example of the present disclosure.

FIG. 4 is a schematic cross-sectional view of a memory cell array comprising a NAND memory string according to an example of the present disclosure.

FIG. 5A is a schematic diagram of an example memory device comprising a memory cell array and a peripheral circuit according to an example of the present disclosure.

FIG. 5B is a schematic diagram of a memory controller according to an example of the present disclosure.

FIG. 6 is a schematic structural diagram of an open zone command in a ZBC according to an example of the present disclosure.

FIG. 7 is a first schematic flowchart of interaction between a ZUFS memory system and a host according to an example of the present disclosure.

FIG. 8 is a second schematic flowchart of interaction between a ZUFS memory system and a host according to an example of the present disclosure.

FIG. 9 is a schematic flowchart of a method of operating a ZUFS memory system according to an example of the present disclosure.

### DETAILED DESCRIPTION

The technical solutions in the implementations of the present disclosure will be clearly and completely described below with reference to the implementations of the present disclosure and the accompanying drawings. It is obvious that the described implementations are only parts of the implementations of the present disclosure and not all implementations. All other implementations based on the examples of the present disclosure obtained by those of ordinary skill in the art without creative efforts shall fall within the scope of the present disclosure.

In the following description, numerous details are given in order to provide a more thorough understanding of the present disclosure. However, it will be apparent to one skilled in the art that the present disclosure may be practiced without one or more of these details. In other examples, in order to avoid confusion with the present disclosure, some technical features known in the art are not described; for example, not all features of the actual example are described here, and well-known functions and structures are not described in detail.

In the accompanying drawings, size of a layer, a region, an element and their relative sizes may be exaggerated for clarity. Like reference numerals refer to like elements throughout.

When an element or layer is referred to as being “on,” “adjacent to,” “connected to” or “coupled to” another element or layer, it may be directly on, adjacent to, connected to or coupled to another element or layer, or intervening elements or layers may be present. In contrast, when an element is referred to as being “directly on,” “directly adjacent to,” “directly connected to” or “directly coupled to” another element or layer, there is no intervening elements or layers present. Although the terms first, second, third etc., may be used to describe various elements, components, regions, layers and/or parts, these elements, components, regions, layers and/or parts should not be limited by these terms. These terms are only used to distinguish one element, component, region, layer or part from another element, component, region, layer or part. Thus, a first element, component, region, layer or part discussed below may be termed as a second element, component, region, layer or part without departing from teachings of the present disclosure. Whereas a second element, component, region, layer or part is discussed, it does not indicate that a first element, component, region, layer or part necessarily presents in the present disclosure.

The spatially relative terms such as “beneath”, “below”, “lower”, “under”, “above”, “on”, etc., may be used herein for ease of description to describe one element or feature's relationship to another element(s) or feature(s) as illustrated in the figures. The spatially relative terms are intended to encompass different orientations of the device in use or operations in addition to the orientation depicted in the drawings. For example, if the device in the appended drawings is turned over, an element or a feature described as “below” or “beneath” or “under” another element or feature would then be oriented “above” the other element or feature. Thus, example terms “below” and “under” may encompass both directions of up and down. A device may be otherwise oriented (rotated 90 degrees or at other orientations) and the spatially relative descriptors used herein is to be interpreted accordingly.

A term used herein is for the purpose of describing a particular example only and is not to be considered as limitation of the present disclosure. As used herein, the singular forms “a”, “an” and “said/the” are intended to include the plural forms as well, unless the context clearly dictates otherwise. The terms “consists of” and/or “comprising”, when used in this description, identify the presence of stated features, integers, steps, operations, elements and/or parts, but do not exclude the presence or addition of one or more other features, integers, steps, operations, elements, parts and/or groups. As used herein, the term “and/or” includes any and all combinations of the associated listed items.

For a thorough understanding of the present disclosure, detailed steps and detailed structures will be presented in the following description in order to explain the technical solutions of the present disclosure. Preferred examples of the present disclosure are described in detail below, however, there may be other implementations in the present disclosure in addition to these detailed description.

Memory devices in examples of the present disclosure include but are not limited to a three-dimensional NAND type memory device, and for ease of understanding, a three-dimensional NAND type memory device is used as an example for illustration.

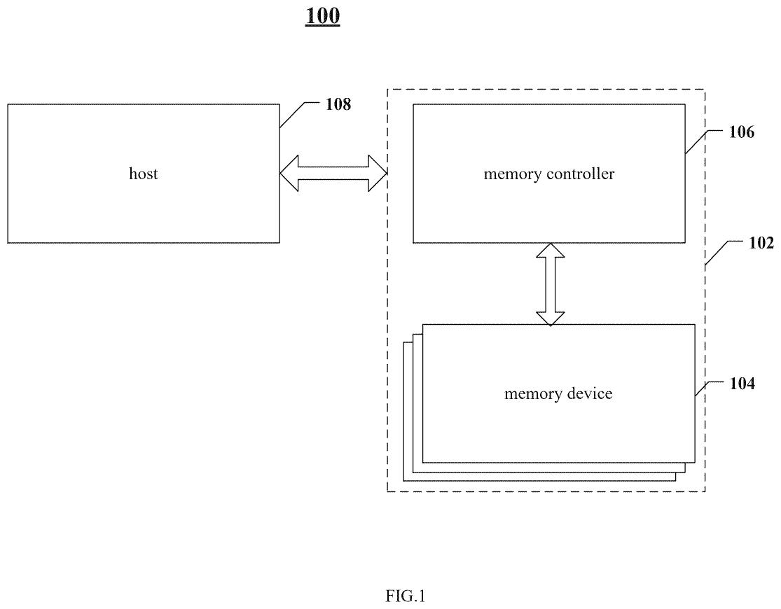

FIG. 1 is a block diagram of an example system 100 with memory devices according to an example of the present disclosure. The system 100 may be a mobile phone, a desktop computer, a laptop computer, a tablet, a vehicle computer, a gaming console, a printer, a positioning device, a wearable electronic device, a smart sensor, a Virtual Reality (VR) device, an Augment Reality (AR) device, or any other suitable electronic devices having storage therein. As shown in in FIG. 1, system 100 may include a host 108 and a memory system 102, and the memory system 102 has one or more memory devices 104 and a memory controller 106. The host 108 may be a processor of an electronic device (e.g., a Central Processing Unit (CPU)) or a System of Chip (SoC) (e.g., an Application Processor (AP)). Host 108 may be configured to send data to or receive data from memory device 104. The host 108 includes a host controller and a second interface for coupling with the memory controller 106. For example, the second interface may also be an interface through which the host communicates with the memory controller.

In some implementations, memory controller 106 is coupled to memory device 104 and host 108 and is configured to control memory device 104. Memory controller 106 may manage data stored in memory device 104 and communicate with host 108. In some implementations, the memory controller 106 is designed to operate in low duty cycle environments, e.g., Secure Digital (SD) card, Compact Flash (CF) card, Universal Serial Bus (USB) flash drive, or other media for use in electronic devices such as personal computer, digital camera, mobile phone, etc. In some implementations, the memory controller 106 is designed to operate in high duty cycle environment Solid State Drive (SSD) or Embedded Multi Media Card (eMMC), where SSD or eMMC is used as data storage for mobile devices such as smartphone, tablet computer, laptop computer, and enterprise storage array.

Memory controller 106 may be configured to control operations of memory device 104, e.g., read, erase and program operations. Memory controller 106 may also be configured to manage various functions related to data stored or to be stored in memory device 104, comprising but not limited to bad block management, garbage collection, logical-to-physical address translation, wear leveling, etc. In some implementations, memory controller 106 is also configured to process error correction code (ECC) related to data read from or written to memory device 104. The memory controller 106 may also perform any other suitable functions, e.g., formatting the memory device 104. Memory controller 106 may communicate with external devices (e.g., host 108) according to a particular communication protocol. For example, the memory controller 106 may communicate with external devices through at least one of various interface protocols, such as USB protocol, MMC protocol, Peripheral Component Interconnection (PCI) protocol, PCI Express (PCI-E) protocol, Advanced Technology Attachment (ATA) protocol, Serial ATA protocol, Parallel ATA protocol, Small Computer Small Interface (SCSI) protocol, Enhanced Small Disk Interface (ESDI) protocol, Integrated Drive Electronics (IDE) protocol, Firewire protocol, etc. These interfaces may also be referred to as a first interface (also referred to as a front-end interface). The first interface herein is an interface coupled with the second interface of the host. In some examples, the memory controller 106 performs command/data interaction with the memory device 104 through a configured plurality of channels. These channels are also referred to as back-end interfaces.

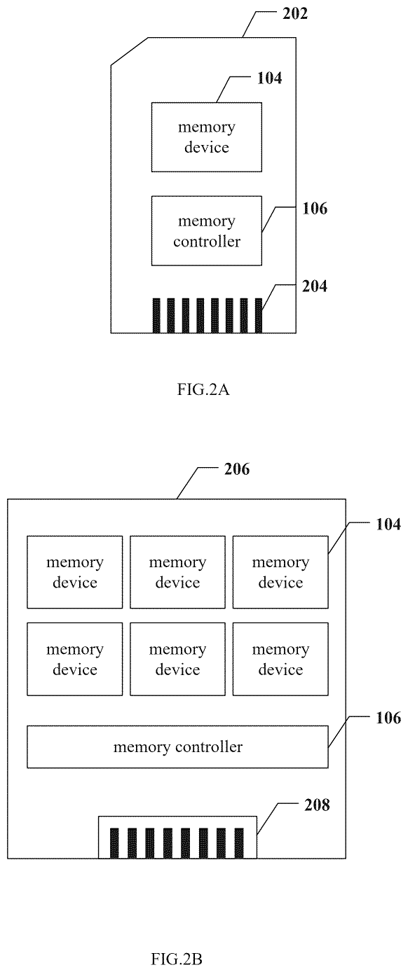

The memory controller 106 and one or more memory device 104 may be integrated into various types of storage devices, e.g., included in the same package (e.g., Universal Flash Storage (UFS) package or eMMC package). For example, memory system 102 may be implemented and packaged into different types of end electronic products. In one example as shown in FIG. 2A, memory controller 106 and a single memory device 104 may be integrated into a memory card 202. Memory card 202 may include a PC card (PCMCIA, personal computer memory card international association), a CF card, a smart media (SM) card, a memory stick, a mulinstant of timedia card (MMC, RS-MMC, MMCmicro), an SD card (SD, miniSD, microSD, SDHC), a UFS, etc. Memory card 202 may further include a memory card connector 204 coupling memory card 202 with a host (e.g., host 108 in FIG. 1). In another example as shown in FIG. 2B, memory controller 106 and multiple memory devices 104 may be integrated into a SSD 206. The SSD 206 may further include an SSD connector 208 coupling the SSD 206 with a host (e.g., host 108 in FIG. 1). In some implementations, the storage capacity and/or operating speed of the SSD 206 is greater than the storage capacity and/or operating speed of memory card 202.

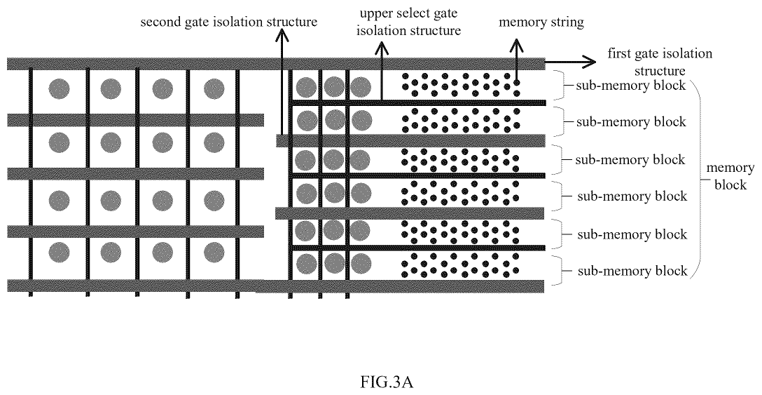

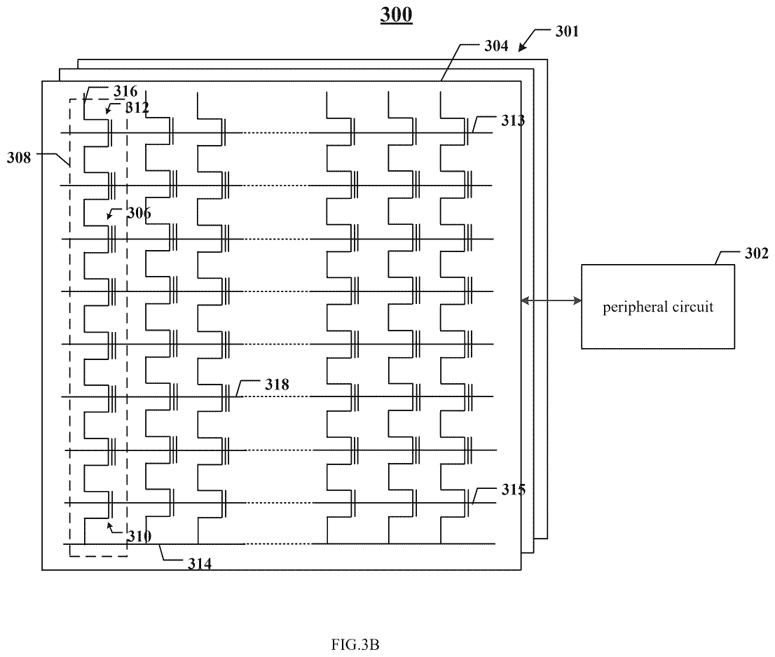

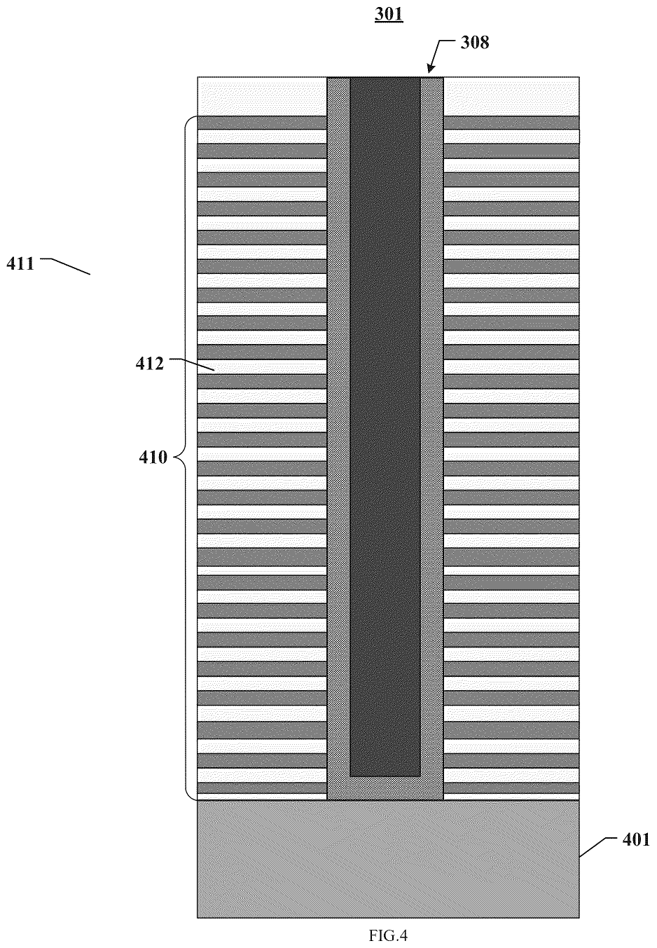

FIG. 3A is a schematic structural diagram of a memory cell array of a three-dimensional NAND type memory device according to an example of the present disclosure. As shown in FIG. 3A, a memory cell array of a three-dimensional NAND type memory device is composed of a plurality of rows of memory cells staggered in parallel and parallel to the gate isolation structure, each two rows of memory cells are separated by a gate isolation structure and an upper select gate isolation structure, and each row of memory cells includes a plurality of memory strings. The gate isolation structure may include a first gate isolation structure and a second gate isolation structure, the first gate isolation structure divides the memory cell array into a plurality of blocks, and the plurality of second gate isolation structures and the upper select gate isolation structure may divide the memory block into sub-memory blocks. One memory block shown in FIG. 3A includes 6 sub-memory blocks, and in practical applications, the number of the sub-memory blocks in one memory block is not limited thereto.

It should be noted that the number of rows of memory cells between the gate isolation structure and the upper select gate isolation structure given in FIG. 3A is merely exemplary, and is not intended to limit the number of rows of memory cells included in one finger of the three-dimensional NAND type memory in the present disclosure. In practical applications, the number of rows of memory cells included in one finger may be adjusted according to actual conditions, such as 2, 4, 8, 16, etc.

FIG. 3B is a schematic circuit diagram of an example memory device 300 comprising a peripheral circuit according to an example of the present disclosure. Memory device 300 may be an example of memory device 104 in FIG. 1. The memory device 300 may include a memory cell array 301 and a peripheral circuit 302 coupled to the memory cell array 301. Taking memory cell array 301 being a three-dimensional NAND type memory cell array as an example for illustration, memory cells 306 are provided in the form of an array of NAND memory strings 308, each memory string 308 extending vertically over a substrate (not shown). In some implementations, each NAND memory string 308 includes multiple memory cells 306 coupled in series and stacked vertically. Each memory cell 306 may retain a continuous analog value, e.g., voltage or charge, depending on the number of electrons trapped within the region of the memory cell 306. Each memory cell 306 may be a “floating gate” type memory cell comprising a floating gate transistor, or a “charge trap” type memory cell comprising a charge trap transistor.

In some implementations, each memory cell 306 is a Single-level Cell (SLC) that has two possible memory states and may thus store one bit of data. For example, a first memory state of “0” may correspond to a first voltage range, and a second memory state of “1” may correspond to a second voltage range. In some implementations, each memory cell 306 is a Multi-Level Cell (MLC) capable of storing more than a single bit of data in more than four memory states. For example, an MLC may store two bits per cell, three bits per cell (also known as a Trinary-Level Cell (TLC)), or four bits per cell (also known as a Quad-Level Cell (QLC)). Each MLC can be programmed to have a range of possible nominal storage values. In one example, if each MLC stores two bits of data, the MLC can be programmed to take one of three possible program levels from the erased state through writing one of three possible nominal storage values into the cell. A fourth nominal storage value may be used for the erase state.

As shown in FIG. 3B, each NAND memory string 308 may include a bottom select gate (BSG) 310 at its source terminal and a top select gate (TSG) 312 at its drain terminal. BSG 310 and TSG 312 may be configured to activate the selected NAND memory string 308 during read operation and program operation. In some implementations, the sources of NAND memory strings 308 in a same memory block 304 are coupled through a same source line (SL) 314 (e.g., a common SL). For example, according to some implementations, all NAND memory strings 308 in a same memory block 304 have an array common source (ACS). According to some implementations, TSG 312 of each NAND memory string 308 is coupled to a corresponding bit line (BL) 316 from which data may be read or written via an output bus (not shown). In some implementations, each NAND memory string 308 is configured to be selected or deselected through applying a select voltage (e.g., above the threshold voltage of a transistor with a TSG 312) or a deselect voltage (e.g., 0V) to the corresponding TSG 312 via one or more TSG lines 313 and/or applying a select voltage (e.g., above the threshold voltage of a transistor with a BSG 310) or a deselect voltage (e.g., 0V) to the corresponding BSG 310 via one or more BSG lines 315.

As also shown in FIG. 3B, a NAND memory string 308 may be organized into multiple memory blocks 304 each of which may have a common source line 314 (e.g., coupled to ground). In some implementations, each memory block 304 is the basic data unit for an erase operation, e.g., all memory cells 306 on the same memory block 304 are erased simultaneously. To erase the memory cell 306 in the selected memory block, the source line 314 coupled to the selected memory block and to the unselected memory blocks in the same plane as the selected memory block may be biased with an erase voltage (Vers) (e.g., a high positive voltage (e.g., 20V or higher)). In some examples, erase operations may be performed at the half-memory block level, at the quarter-memory block level, or at a level with any suitable number of memory blocks or any suitable fraction of memory blocks. The memory cells 306 of adjacent NAND memory strings 308 may be coupled through a word line 318 that selects which row of memory cells 306 is affected by read and program operations.

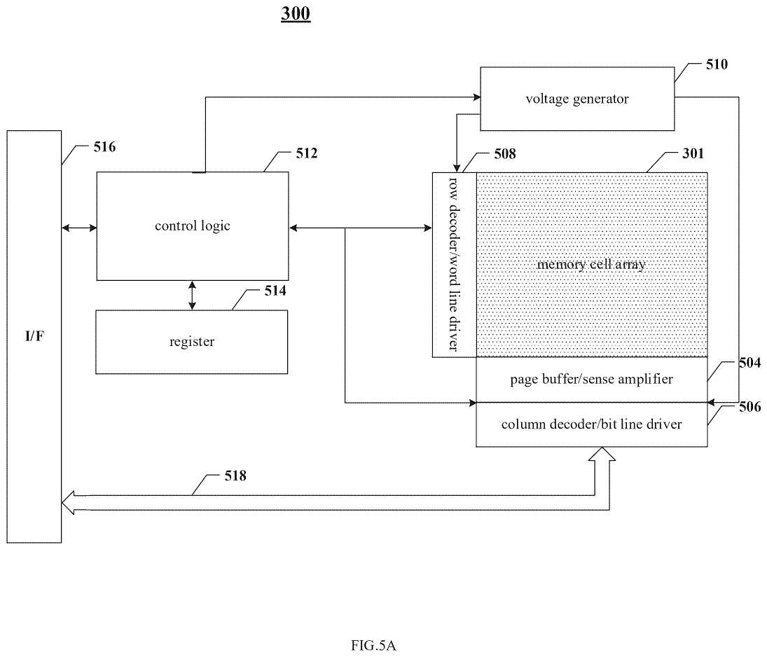

FIG. 4 is a schematic cross-sectional view of an example memory cell array 301 comprising a NAND memory string 308 according to an example of the present disclosure. As shown in FIG. 4, the NAND memory string 308 may include a stacked structure 410, the stacked structure 410 includes multiple gate layers 411 and multiple insulating layers 412 alternately stacked in sequence, and the memory string 308 vertically penetrating through the gate layers 411 and the insulating layers 412. Gate layers 411 and the insulating layers 412 may be stacked alternately, and two adjacent gate layers 411 are separated by an insulating layer 412. The number of pairs of gate layers 411 and insulating layers 412 in the stacked structure 410 may determine the number of memory cells included in the memory cell array 301.

A constituent material of the gate layer 411 may include a conductive material. Conductive materials include, but are not limited to, tungsten (W), cobalt (Co), copper (Cu), aluminum (Al), polysilicon, doped silicon, silicide, or any combination thereof. In some examples, each gate layer 411 includes a metal layer, e.g., a tungsten layer. In some examples, each gate layer 411 includes a doped polysilicon layer. Each gate layer 411 may include a control gate surrounding a memory cell. A gate layer 411 at the top of a stacked structure 410 may extend laterally as a top select gate line, a gate layer 411 at the bottom of a stacked structure 410 may extend laterally as a bottom select gate line, and a gate layer 411 extending laterally between a top select gate line and a bottom select gate line may serve as a word line layer.

In some implementations, a stacked structure 410 may be disposed on a semiconductor layer 401. The semiconductor layer 401 may include silicon (e.g., monocrystalline silicon), silicon germanium (SiGe), gallium arsenide (GaAs), germanium (Ge), silicon-on-insulator (SOI), germanium-on-insulator (GOI), or any other appropriate material.

In some implementations, a NAND memory string 308 includes a channel structure extending vertically through stacked structure 410. In some implementations, a channel structure includes a channel hole filled with semiconductor material(s) (e.g., as a semiconductor channel) and dielectric material(s) (e.g., as a memory film). In some implementations, a semiconductor channel includes silicon, e.g., polysilicon. In some implementations, a memory film is a composite dielectric layer comprising a tunneling layer, a storage layer (also referred to as a “charge trapping/storage layer”), and a blocking layer. A channel structure may have a cylindrical shape (e.g., a pillar shape). According to some implementations, a semiconductor channel, a tunneling layer, a storage layer and a blocking layer are radially arranged in this order from the center of the pillar toward the outer surface of the pillar. A tunneling layer may include silicon oxide, silicon oxynitride, or any combination thereof. A storage layer may include silicon nitride, silicon oxynitride, or any combination thereof. A blocking layer may include silicon oxide, silicon oxynitride, a high-k (high-k) dielectric, or any combination thereof. In an example, a memory film may include a composite layer of silicon oxide/silicon oxynitride/silicon oxide (ONO).

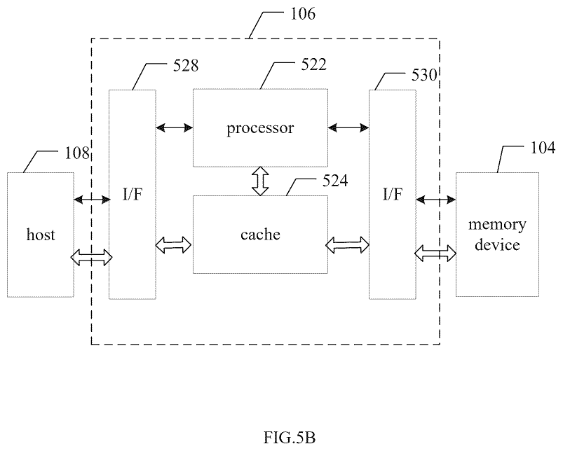

Referring back to FIG. 3B, the peripheral circuit 302 may be coupled to the memory cell array 301 through bit line 316, word line 318, source line 314, BSG line 315, and TSG line 313. The peripheral circuit 302 may include any suitable analog, digital, and mixed-signal circuitry for facilitating operation of the memory cell array 301 through applying a voltage signal and/or a current signal to and sensing voltage signal and/or current signal from each target memory cell 306 via bit line 316, word line 318, source line 314, BSG line 315, and TSG line 313. The peripheral circuit 302 may include various types of peripheral circuits formed with metal-oxide-semiconductor (MOS) technology. FIG. 5A is a schematic diagram of an example memory device comprising a memory cell array and a peripheral circuit according to an example of the present disclosure, where the peripheral circuit 302 includes page buffer/sense amplifier 504, column decoder/bit line driver 506, row decoder/word line driver 508, voltage generator 510, control logic 512, register 514, interface 516 and data bus 518. In some examples, additional peripheral circuits not shown in FIG. 5A may also be included.

Control logic 512 may be coupled to each peripheral circuit described above and configured to control operation of each peripheral circuit. Registers 514 may be coupled to control logic 512 and include state registers, command registers, and address registers for storing state information, command operation codes (OP codes), and command addresses for controlling operation of each peripheral circuit. Interface 516 may be coupled to control logic 512 and act as a control buffer to buffer control commands received from a host (not shown) and relay it to control logic 512 and buffer state information received from control logic 512 and relay it to the host. The interface 516 may also be coupled to the column decoder/bit line driver 506 via a data bus 518 and act as a data I/O interface and a data buffer to buffer data and relay it to the memory cell array 301 or relay or buffer data from the memory cell array 301. For example, the interface 516 herein is an interface coupled with the back-end interface of the aforementioned memory controller. For example, the interface 516 may also be an interface through which the memory device communicates with the memory controller.

In some implementations, the page buffer/sense amplifier 504 may be configured to read data from and program (write) data to the memory cell array 301 according to control signals from the control logic 512. In one example, the page buffer/sense amplifier 504 may store program data (written data) to be programmed into the memory cells 306 of the memory cell array 301. In another example, the page buffer/sense amplifier 504 may perform a program verify operation to ensure that data has been correctly programmed into memory cell 306 coupled to selected word line 318. The column decoder/bit line driver 506 may be configured to be controlled by control logic 512 and to select one or more NAND memory strings 308 through applying a bit line voltage generated from voltage generator 510.

The row decoder/word line driver 508 may be configured to be controlled by control logic 512 and to select/deselect memory block 304 of memory cell array 301 and to select/deselect word line 318 of memory block 304. The row decoder/word line driver 508 may also be configured to drive word line 318 with a word line voltage generated from voltage generator 510. In some implementations, the row decoder/word line driver 508 may also select/deselect and drive the BSG line 315 and the TSG line 313. As described in detail below, the row decoder/word line driver 508 is configured to perform program operations on the memory cells 306 coupled to the selected word line 318. The voltage generator 510 may be configured to be controlled by the control logic 512, and generate word line voltage (e.g., read voltage, program voltage, pass voltage, channel boost voltage, verify voltage, etc.), bit line voltage and source line voltage to be supplied to the memory cell array 301.

FIG. 5B is a schematic diagram of a memory controller 106 according to an example of the present disclosure. The memory controller 106 may include one or more processors 522 and a memory module comprising a cache 524. The memory controller 106 may further include an interface (I/F) 528 (e.g., a first interface) coupled with the host 108 and an interface (I/F) 530 (e.g., a back-end interface) coupled with the memory device 104. The first interface herein is an interface coupled with the second interface of the host. The processor 522 may include an arithmetic logic unit (ALU) for performing arithmetic and logical operations. Interface 528 may receive instructions and data from host 108 and buffer instructions and data to processor 522 and cache 524, respectively. Interface 530 may transmit control signals and data from processor 522 and cache 524 to memory device 104, respectively.

The examples of the present disclosure provide a zoned universal flash storage (ZUFS) memory system, and the specific structure and composition of the memory system may refer to the related structure and composition of the memory system 102 in FIG. 1, FIG. 2A and FIG. 2B. For brevity, details are not described herein again. The ZUFS memory system includes: a memory device; and a memory controller coupled with the memory device and configured to control the memory device to perform partition storage by zones, where a storage space of a zone is configured to support sequential writing; where the memory controller is configured with a first interface for coupling with the host, and receives a first command from the host through the first interface, where the first command includes specified mode information indicating a storage mode of a to-be-created zone; and the memory controller is further configured to: determine whether available storage space of the memory device satisfies a creation condition according to the specified mode information; and in response to the available storage space satisfying the creation condition, create the zone with the storage mode according to the first command.

In some implementations, the memory system 102 in FIG. 1, FIG. 2A, and FIG. 2B is a memory system conforming to a Zoned Universal Flash Storage (ZUFS) standard, referred to as a ZUFS memory system for short. The communication interface (e.g., the first interface and the second interface) between the ZUFS memory system and the host may perform communication according to the specifications described in the UFS specification of the JEDEC standard.

In some implementations, the zone is a zone in a zone namespace (ZNS). The ZNS includes a plurality of zones. A zone is a fixed-size sub-interval in the ZNS, and each zone has a Logical Block Address (LBA) interval. The number of logical block addresses corresponding to each zone may be the same. In some implementations, each of the plurality of zones in the ZNS may have the same configuration. Typically, in ZNS, an external device (e.g., a host) provides a definition of a logical block address to a memory system. For example, the host may indicate an LBA interval corresponding to a first zone, an LBA interval corresponding to a second zone, and so on. The ZUFS memory system then maps each zone in the ZNS to a physical block in the memory device. For example, the ZUFS memory system may map an LBA corresponding to the first zone to a first physical block, map an LBA corresponding to the second zone to a second physical block, and so on.

In some implementations, a storage capacity of a single zone is less than a storage capacity corresponding to a physical block of the memory device. Herein, storage capacity may refer to the amount of storage space provided by the memory device.

In some implementations, the zone namespace (ZNS) may have a preset or adjustable storage capacity. ZUFS memory systems that support zone namespace (ZNS) may create multiple zones such that the memory controller may control the memory devices to perform partition storage by zones. For example, the data transferred by the host may be stored in a zone, and the ZUFS memory system may allocate at least one memory block or a portion of one memory block for each zone. The ZUFS memory system may sequentially store data transferred by the host in a corresponding zone specified by LBA.

In some implementations, the storage capacity of the zone is close to the storage capacity corresponding to an erase block. In a specific example, the storage capacity of the zone is the same as the storage capacity corresponding to the erase block, or the storage capacity of the zone is an integer multiple of the storage capacity corresponding to the erase block, or the storage capacity corresponding to the erase block is an integer multiple of the storage capacity of the zone. Since garbage collection is moved from the memory device to the host, if the storage capacity of the zone is an integer multiple of the storage capacity corresponding to the erase block, write amplification caused by garbage collection on the memory device side can be eliminated. If the storage capacity corresponding to the erase block is an integer multiple of the storage capacity of the zone, the memory device still needs to perform garbage collection.

In ZUFS memory systems that support zone namespace ZNS, zones in zone namespace ZNS only support sequential writing without supporting random writing, and zones in zone namespace ZNS may support random reading and sequential reading.

In some implementations, the creation condition includes that the available storage space of the memory device is greater than a storage space occupied by the to-be-created zone. For example, the available storage space in the memory device needs to satisfy the requirement of zone creation.

In some implementations, the first command may be used to indicate to create a plurality of zones having a storage mode indicated by the specified pattern information, and as such, the creation condition includes that the available storage space of the memory device is greater than the storage space occupied by the plurality of to-be-created zones.

According to the examples of the present disclosure, the zone with the storage mode indicated by the specified mode information can be created by the first command.

In some implementations, the memory controller is configured to: in response to the available storage space not satisfying the creation condition, send a creation failure information (open zone fail) to the host through the first interface.

In some examples, after receiving the creation failure information through the second interface, the host may send a second command to the memory controller, where the second command is used to instruct the memory controller to configure the at least one zone in the non-full state in the memory device with the storage mode indicated by the specified pattern information. Here, the second command may be a Reset Write Pointer Command in the ZBC.

In some implementations, the second command includes an identifier of the specified zone and mode switching information of the specified zone; and the memory controller is configured to switch the storage mode of the specified zone to the storage mode indicated in the mode switching information according to the mode switching information. Therefore, the memory controller may switch the storage mode of the specified zone to the storage mode indicated by the mode switching information according to the second command.

In some implementations, the storage mode includes a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

In some implementations, the memory controller determines the storage mode of the to-be-created zone to be the first storage mode or the second storage mode according to the specified mode information. Specifically, when the specified mode information indicates that the storage mode of the to-be-created zone is the first storage mode, the memory controller creates the zone with the first storage mode according to the first command; when the specified mode information indicates that the storage mode of the to-be-created zone is the second storage mode, the memory controller creates the zone with the second storage mode according to the first command.

As described above, in NAND type memory devices, memory cells can be divided into single-level cells (SLCs) and multi-level cells (MLCs) according to differences in storage density. Correspondingly, the first storage mode may be a single-level cell (SLC) storage mode, for example, N=1, and the second storage mode may be a multi-level cell (MLC) storage mode, for example, M is an integer greater than 1. A storage density of the first storage mode is less than a storage density of the second storage mode, for example, N is less than M. The multi-level cell (MLC) storage mode may be at least one of a two-level cell storage mode, a triple-level cell (TLC) storage mode, a quad-level cell (QLC) storage mode. When M=2, the second storage mode is the two-level cell storage mode; when M=3, the second storage mode is the TLC storage mode; and when M=4, the second storage mode is the QLC storage mode.

In a specific example, the zone with the SLC storage mode can be created by the first command. In another specific example, the zone with the MLC storage mode can be created by the first command.

In some implementations, the ZUFS memory system may include one or more conventional namespaces (CNSs) in addition to the zone namespace ZNS.

In some implementations, the first command includes a Zoned Block Command (ZBC). For example, the first command may be a command in the ZBC for configuring a zone. In a specific example, the first command may be an Open Zone Command in the ZBC. Here, the first command is a command conforming to a Zoned Universal Flash Storage (Zoned UFS) protocol format.

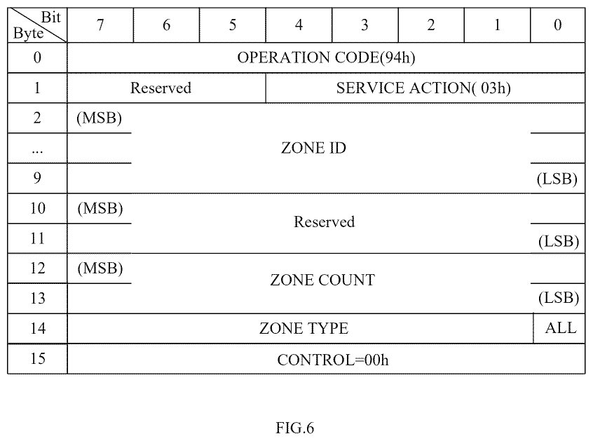

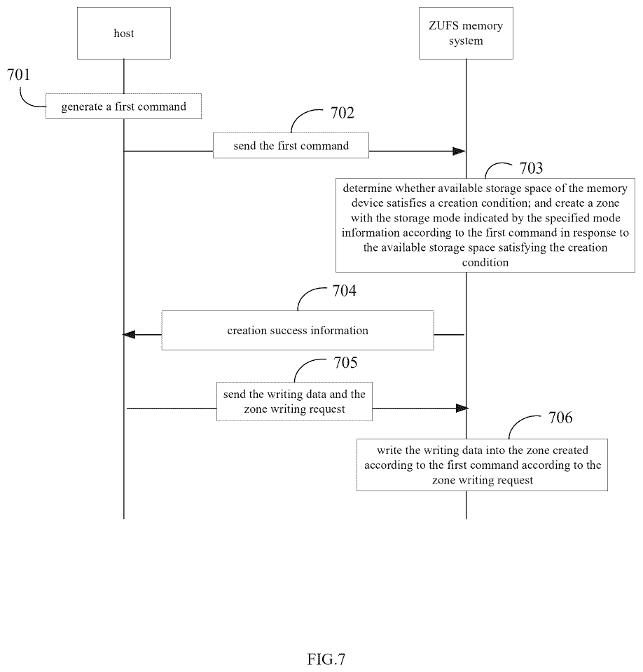

FIG. 6 is a schematic structural diagram of an open zone command in a ZBC according to an example of the present disclosure. Referring to FIG. 6, the open zone command may include an OPERATION CODE field, a SERVICE ACTION field, a ZONE ID field, a ZONE COUNT field, a CONTROL byte, and a Reserved field, among others. The fields and information included in the open zone command may be understood with reference to the ZBC specification. In the example of FIG. 6, the ZONE ID is the identifier of the to-be-created zone, and the ZONE TYPE is the specified mode information.

In some implementations, the memory controller is configured to: create and open a zone in response to the open zone command. Opening the zone refers to setting the state of the created zone to an open state.

In some implementations, the memory controller is configured to: reset the state of the specified zone to the empty state according to the reset write pointer command. Since the reset write pointer command may reset the write pointer to the initial value, e.g., point the write pointer to the starting LBA of the zone, the state of the specified zone may be reset to the empty state by resetting the write pointer command.

In some implementations, the state of the zone includes an Empty state, an Open state, and a Full state. In the empty state, there is no valid data in the zone, and its write pointer is set to the starting LBA in the zone (i.e., WP=0). After the state of the zone is switched from the empty state to the open state, data writing may be performed on the zone, and in the open state, there may or may not be valid data in the zone, its write pointer points to a certain location between the starting LBA and the end of the last LBA in the zone(i.e., WP>0), and the storage space corresponding to the zone may receive the writing data for data writing through the write command. Additionally, the host may clear or erase valid data stored in the zone by resetting the zone, such that the zone is reset to an empty state. Once the storage space corresponding to the zone is full, the zone is switched to the full state. In the full state, the storage space corresponding to the zone is full and cannot be opened again to receive the writing data. At this point, the write pointer points to the LBA of the next zone. If each zone in the ZNS is full, the write pointer points to the end of the last LBA of the zone (i.e., WP=ZCAP). Here, ZCAP is the capacity of the zone.

In some implementations, the open zone command may trigger a transition of the zone from the empty state to the open state. The use of a reset write pointer command in any case may transition the zone to the empty state. In some implementations, the state of the zone further includes a close state, and the close zone command may trigger the transition of the zone from the open state to the close state. In the close state, if the write pointer points to the starting LBA in the zone, then the state of the zone will transition to the empty state. The write pointer pointing to the end of the last LBA may trigger the zone to transition to the full state, and the FINISH zone command may also trigger the zone to transition to the full state.

In some implementations, where the open zone command is used to trigger a transition of the zone from the empty state to the open state, the memory controller may determine whether the zone requested by the open zone command to be opened may be opened. For example, the memory controller may determine whether the requested zone is available to be opened. Specifically, when the state machine variable is set to FAILURE, then the requested zone may not be opened, e.g., the memory controller does not perform the open zone operation. At this point, the memory controller may send information about the requested zone cannot be opened or creation failure information to the host. When the state machine variable is set to SUCCESS, the requested zone may be opened, e.g., the memory controller may perform the open zone operation. At this point, the memory controller may send information about the requested zone can be opened or creation success information to the host. Here, when the state machine variable is set to the SUCCESS, it indicates that sufficient open zone resources are available for use. For example, there are zones that can be opened; and when the state machine variable is set to FAILURE, it indicates that the available open zone resources are insufficient, e.g., there is no zone that can be opened.

In some implementations, the specified pattern information is included in an unused reserved field in an open zone command based on an existing ZBC specification. In a specific example, referring to FIG. 6, the specified pattern information (ZONE TYPE) occupies the first the eighth bits of the fifteenth byte in the open zone command.

In a specific example, when the specified mode information is 01h, it indicates that the storage mode indicated by the specified mode information is the SLC storage mode; and when the specified mode information is 02h, it indicates that the storage mode indicated by the specified mode information is the MLC storage mode.

In some other implementations, the first storage mode may be an SLC storage mode, the second storage mode may be an MLC storage mode, and the second storage mode may further include a TLC storage mode and a QLC storage mode. In a specific example, when the specified mode information is 00h, it indicates that the storage mode indicated by the specified mode information is the SLC storage mode; when the specified mode information is 01h, it indicates that the storage mode indicated by the specified mode information is the TLC storage mode; and when the specified mode information is 02h, it indicates that the storage mode indicated by the specified mode information is the QLC storage mode.

In some implementations, the mode switching information may be included in unused reserved fields in a reset write pointer command based on an existing ZBC specification. In some implementations, the mode switching information occupies a field of two bits in the reset write pointer command. In a specific example, the mode switch information occupies a first bit to a second bit of the fourteenth byte in the reset write pointer command.

In a specific example, the mode switching information may be used to indicate a storage mode of a specified zone. When the mode switching information is 01h, it indicates that the storage mode of the specified zone is the first storage mode; and when the mode response information is 02h, it indicates that the storage mode of the specified zone is the second storage mode.

In a specific example, when the mode switching information is 00h, it indicates that the storage mode of the specified zone is not switched. It should be noted that when a value of the ALL bit in the reset write pointer command is 1, the mode switching information in the write pointer command is ignored.

In a specific example, when the mode switching information is 01h, if the current storage mode of the specified zone is the first storage mode, which is the same as the storage mode indicated in the mode switching information, the storage mode of the specified zone is not switched; if the current storage mode of the specified zone is the second storage mode, which is different from the storage mode indicated in the mode switching information, the specified zone is switched from the second storage mode to the first storage mode. When the mode switching information is 02h, if the current storage mode of the specified zone is the second storage mode, which is the same as the storage mode indicated in the mode switching information, the storage mode of the specified zone is not switched; and if the current storage mode of the specified zone is the first storage mode, which is different from the storage mode indicated in the mode switching information, the specified zone is switched from the first storage mode to the second storage mode.

In some implementations, the memory controller is configured to: set the state of the created zone to an open state and send creation success information (open zone success) to the host through the first interface.

In some implementations, the memory controller is further configured to: receive the zone writing request and the writing data through the first interface, and write the writing data into the created zone according to the zone writing request. As described above, if the available storage space does not satisfy the creation condition, after receiving the creation failure information, the host sends a second command to the memory controller, so that the memory controller can configure the at least one zone in the non-full state in the memory device with the storage mode indicated by the mode switching information according to the second command. Therefore, before the host sends the zone writing request and the writing data, there is a zone in the memory device where the writing data can be written.

In some implementations, the memory controller is further configured to: receive the zone writing request and the writing data through the first interface, where if the writing data is hot data, the storage mode indicated by the specified mode information is the first storage mode, and if the writing data is non-hot data, the storage mode indicated by the specified mode information is the second storage mode; and write the writing data into the zone created according to the first command according to the zone writing request.

In some implementations, if the storage space does not satisfy the creation condition, the memory controller cannot create a zone with a storage mode indicated by the specified mode information according to the first command, and writes the writing data into the zone configured according to the second command according to the zone writing request.

Here, the non-hot data refers to data for which access frequency is lower than the reference value set by the memory device, and the predetermined storage duration thereof is relatively long; and the hot data refers to data for which access frequency is higher than the reference value set by the memory device, and the predetermined storage duration thereof is relatively low. The non-hot data includes cold data and warm data, and the access frequency of the warm data is larger than the cold data, but lower than the hot data. Therefore, the zone with the storage mode of the first storage mode may be used to store the hot data with a shorter predetermined storage duration, and the zone with the storage mode of the second storage mode may be used to store the non-hot data with a longer predetermined storage duration. In this way, the host may create or configure the zone corresponding to the storage mode for the writing data based on its cold-hot attribute, so that the writing speed and the reading speed of the hot data can be improved.

In the examples of the present disclosure, on the host side: by adding the specified mode information in the open zone command, the specified mode information may be set based on the actual demand, so that the storage mode of the to-be-created zone can be controlled. Correspondingly, on the ZUFS memory system side: a zone with a storage mode indicated by the specified mode information can be created based on the specified mode information in the open zone command. According to the examples of the present disclosure, the existing ZBC command can be utilized to create the zone with the specified storage mode.

In the examples of the present disclosure, on the host side: by adding the mode switching information in the reset write pointer command, the mode switching information may be set based on the actual demand, so that the storage mode of the specified zone may be controlled. Correspondingly, on the ZUFS memory system side: the storage mode of the specified zone can be switched to the storage mode indicated in the mode switching information based on the mode switching information in the reset write pointer command. According to the examples of the present disclosure, the existing ZBC command can be utilized to switch the specified zone between the first storage mode and the second storage mode.

In the examples of the present disclosure, when data writing is performed, a zone with the first storage mode may be selectively created or configured for the hot data based on the cold-hot attribute of the writing data, and a zone with the second storage mode may be created or configured for the non-hot data. In this way, the writing speed and the reading speed of the hot data can be improved.

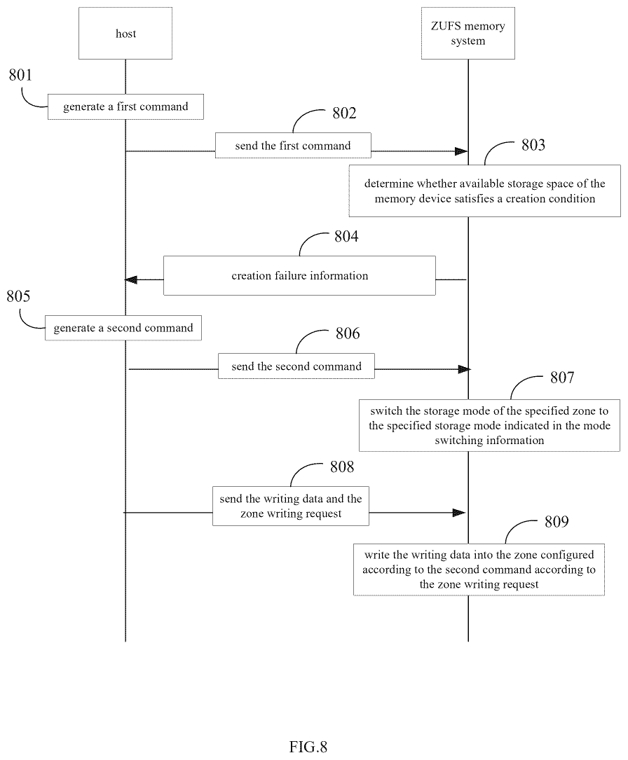

The examples of the present disclosure provide a system. Here, the specific structure and composition of the system may refer to the related structure and composition of FIG. 1. For brevity, details are not described herein again. FIG. 7 is a first schematic flowchart of interaction between a ZUFS memory system and a host according to an example of the present disclosure, and a workflow of the system is described with reference to FIG. 7 and FIG. 1. All steps may not be required in the interaction of the ZUFS memory system with the host, and the operation steps shown in FIG. 7 may not be exhaustive, and other operation steps may also be performed before, after, or between any of the illustrated operation steps. Further, some of the operation steps may be performed concurrently, or in a different order than shown in FIG. 7. The system includes a ZUFS memory system and a host; where the ZUFS memory system includes a memory device and a memory controller coupled with the memory device and configured to control the memory device to perform partition storage by zones, where the storage space of the zone is configured to support sequential writing; the host includes a host controller and a second interface for coupling with the memory controller, and at the step 701: the host controller is configured to generate a first command; at step 702: send the first command to the memory controller through the second interface, where the first command includes specified mode information, and the specified mode information indicates a storage mode of the to-be-created zone; and the memory controller is configured with a first interface for coupling with the second interface, and the memory controller receives the first command from the host through the first interface; at step 703: determine whether available storage space of the memory device satisfies a creation condition according to the specified mode information; and in response to the available storage space satisfying the creation condition, create the zone with the storage mode indicated by the specified mode information according to the first command.

In some implementations, the zone is a zone in a zone namespace (ZNS). The storage capacity of each zone is less than the storage capacity corresponding to the physical block of the memory device. Herein, storage capacity may refer to the amount of storage space provided by the memory device. The zone namespace (ZNS) may have a preset or adjustable storage capacity. ZUFS memory systems that support zone namespace (ZNS) may create multiple zones such that the memory controller may control the memory devices to perform partition storage by zones. For example, the data transferred by the host may be stored in a zone, and the ZUFS memory system may allocate at least one memory block or a portion of one memory block for each zone. The ZUFS memory system may sequentially store data transferred by the host in a corresponding zone specified by LBA. In the memory system supporting the zone namespace ZNS, the zones in the zone namespace ZNS only support sequential writing without supporting random writing, and the zones in the zone namespace ZNS can support random reading and sequential reading.

In some implementations, the first command includes an open zone command. The specified pattern information occupies a field of seven bits in the open zone command. In a specific example, the specified pattern information occupies a first bit to an eighth bit of the fifteenth byte in the open zone command. The open zone command may be understood with reference to FIG. 6, and details are not described herein again. The specified mode information is used to indicate a storage mode of a to-be-created zone.

In some implementations, the storage mode includes a first storage mode and a second storage mode. The first storage mode may be a single-level cell (SLC) storage mode and the second storage mode may be a multi-level cell (MLC) storage mode. In a specific example, when the specified mode information is 01h, it indicates that the storage mode is the SLC storage mode; and when the specified mode information is 02h, it indicates that the storage mode is the MLC storage mode.

In some other implementations, the storage mode includes a first storage mode and a second storage mode. The first storage mode may be an SLC storage mode, the second storage mode may be an MLC storage mode, and the second storage mode may specifically include a TLC storage mode and a QLC storage mode. In a specific example, when the specified mode information is 00h, it indicates that the storage mode is the SLC storage mode; when the specified mode information is 01h, it indicates that the storage mode is the TLC storage mode; and when the specified mode information is 02h, it indicates that the storage mode is the QLC storage mode.

In some implementations, at step 704, the memory controller is configured to: set a state of the created zone to an open state, and send creation success information to the host through the first interface.

In some implementations, the creation condition includes that an available storage space of the memory device is greater than a storage space occupied by the to-be-created zone.

In some implementations, at step 701, the host controller is configured to: generate a corresponding first command according to a cold-hot attribute of writing data; if the writing data is hot data, the storage mode in the first command is the first storage mode, and if the writing data is non-hot data, the storage mode in the first command is the second storage mode.

Specifically, if the writing data is hot data, the storage mode in the first command is used to indicate that the storage mode of the to-be-created zone is the first storage mode, at this point, the memory controller creates, in response to the available storage space satisfying the creation condition, the zone with the first storage mode according to the first command; if the writing data is non-hot data, the storage mode in the first command is used to indicate that the storage mode of the to-be-created zone is the second storage mode, and the memory controller creates, in response to the available storage space satisfying the creation condition, the zone with the second storage mode according to the first command.

In some implementations, at step 705, the host controller is configured to: generate a zone writing request corresponding to the writing data, and send the writing data and the zone writing request to the memory controller through the second interface.

In some implementations, at step 706, receiving the zone writing request and the writing data through the first interface, and writing the writing data into the zone created according to the first command according to the zone writing request.

Specifically, if the writing data is hot data, the memory controller writes the writing data into the zone with the first storage mode created according to the first command according to the zone writing request; and if the writing data is non-hot data, the memory controller writes the writing data into the zone with the second storage mode created according to the first command according to the zone writing request.

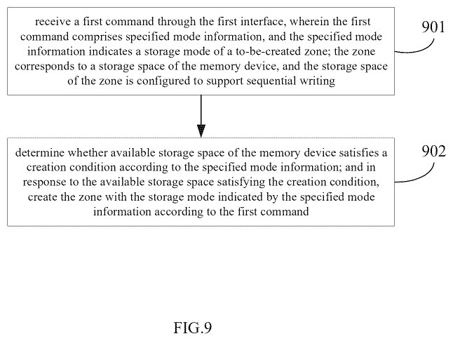

FIG. 8 is a second schematic flowchart of interaction between a ZUFS memory system and a host according to an example of the present disclosure. All the steps may not be required in the interaction between the ZUFS memory system and the host illustrated in FIG. 7 and FIG. 8, and the operation steps shown in FIG. 7 and FIG. 8 may not be exhaustive, and other operation steps may be performed before, after, or between any operation steps in the operation steps shown. Further, some of the operation steps may be performed concurrently, or in a different order than shown in FIGS. 7 and 8. The workflow of the system will be described in conjunction with FIG. 7, FIG. 8 and FIG. 1. Referring to FIG. 8, a system includes: a ZUFS memory system and a host; where the ZUFS memory system includes: a memory device and a memory controller coupled with the memory device and configured to control the memory device to perform partition storage by zones, where the storage space of the zone is configured to support sequential writing; the host includes a host controller and a second interface for coupling with the memory controller, at step 801: the host controller is configured to generate a first command; at step 802: send a first command to the memory controller through the second interface, where the first command includes specified pattern information, and the specified pattern information indicates a storage mode of a to-be-created zone; and the memory controller is configured with a first interface for coupling with the second interface, and the memory controller receives the first command from the host through the first interface; at step 803: the memory controller is configured to: determine whether the available storage space of the memory device satisfies the creation condition according to the specified pattern information; at step 804: the memory controller is configured to: in response to the available storage space not satisfying the creation condition, send the creation failure information to the host through the first interface.

In some implementations, the creation condition includes that an available storage space of the memory device is greater than a storage space occupied by the to-be-created zone.

In some implementations, at step 805: the host controller is configured to generate a second command, and at step 806: send the second command to the memory controller through the second interface, and the second command includes the identifier of the specified zone and the mode switching information of the specified zone; and step 807 specifically includes: the memory controller is configured to switch the storage mode of the specified zone to the storage mode indicated in the mode switching information according to the mode switching information.

Specifically, if the writing data is hot data, the mode switching information in the second command is used to indicate to switch the storage mode of the specified zone to the first storage mode, and at this point, the memory controller configures the storage mode of the specified zone to the first storage mode according to the second command; if the writing data is non-hot data, the mode switching information in the second command is used to indicate to switch the storage mode of the specified zone to the second storage mode, and at this point, the memory controller configures the storage mode of the specified zone to the second storage mode according to the second command.

In some implementations, at step 808: the host controller is configured to generate a zone writing request corresponding to the writing data and send the writing data and the zone writing request to the memory controller through the second interface.

In some implementations, at step 809: receiving the zone writing request and the writing data through the first interface, and writing the writing data into the zone configured according to the second command according to the zone writing request.

Specifically, if the writing data is hot data, the memory controller writes the writing data into the zone having the first storage mode configured according to the second command according to the zone writing request; if the writing data is non-hot data, the memory controller writes the writing data into the zone having the second storage mode configured according to the second command according to the zone writing request.

As described above, if the available storage space does not satisfy the creation condition, after receiving the creation failure information, the host sends a second command to the memory controller, so that the memory controller can configure at least one zone in the memory device in the non-full state with the storage mode according to the second command. Therefore, before the host sends the zone writing request and the writing data, there is a zone in the memory device where the writing data can be written.

In some implementations, the host controller may issue a control command to the memory controller, and the memory controller controls program operations, erase operations, read operations, and other operations by the memory device according to the control command. Here, other operations may include at least one of a garbage collection operation, a wear leveling operation, a read recovery operation, and a bad block management operation.

In some implementations, the host controller may send a command to perform garbage collection on the specified zone to the memory controller. After receiving the command, the memory controller performs a garbage collection operation and a related operation on the storage space corresponding to the specified zone, and the related operation may include a wear leveling operation, a read recovery operation, and the like.

In some implementations, the garbage collection operation initiated by the host controller may include a series of operations, comprising, for example, operations to store valid data in a specified zone into another zone, and operations to reset a specified zone. In this case, the operation performed by the memory controller on the storage space corresponding to the specified zone after receiving the command may include: a read operation and a program operation for storing valid data in the specified zone into another zone, and may include an erase operation for resetting the specified zone.

In some implementations, since the storage space of the zone is configured to support sequential writing, the writing data may be sequentially written to the zone in the ZNS, so that garbage collection may be performed from the first zone in the ZNS when garbage collection is performed, then garbage collection is performed on the second zone in the ZNS, and so on. It should be noted that the zone on which the garbage collection is performed needs to include invalid data and the zone is in a close state.

The description of the above system example is similar to the description of the above ZUFS memory system example, and has the beneficial effects similar to that of the ZUFS memory system example. Technical details not disclosed in the system examples of the present disclosure should be understood referring to the description of the ZUFS memory system example of the present disclosure.

FIG. 9 is a schematic flowchart of a method of operating a ZUFS memory system according to an example of the present disclosure. Here, the specific structure and composition of the ZUFS memory system may refer to the related structure and composition of the memory system 102 in FIG. 1, FIG. 2A and FIG. 2B. For brevity, details are not described herein again. The operation steps shown in FIG. 9 may not be exhaustive, and other operation steps may also be performed before, after, or between any of the illustrated operation steps. Further, some of the operation steps may be performed concurrently, or in a different order than shown in FIG. 9. Referring to FIG. 9, at step 901: receiving a first command through the first interface, where the first command includes specified mode information, and the specified mode information indicates a storage mode of a to-be-created zone; the zone corresponds to a storage space of the memory device, and the storage space of the zone is configured to support sequential writing. At step 902: determining whether available storage space of the memory device satisfies a creation condition according to the specified mode information; and in response to the available storage space satisfying the creation condition, creating the zone with the storage mode indicated by the specified mode information according to the first command.

In some implementations, the method further includes: setting a state of the created zone to an open state, and sending creation success information to the host through the first interface.

In some implementations, the method further includes: in response to the available storage space not satisfying the creation condition, sending creation failure information to the host through the first interface.

In some implementations, the creation condition includes that the available storage space of the memory device is greater than a storage space occupied by the to-be-created zone.

In some implementations, the storage mode includes a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

In some implementations, the method further includes: receiving the zone writing request and the writing data through the first interface, where if the writing data is hot data, the storage mode indicated by the specified mode information is the first storage mode, and if the writing data is non-hot data, the storage mode indicated by the specified mode information is the second storage mode; and writing the writing data into the zone created according to the first command according to the zone writing request.

In some implementations, the first command includes an open zone command, and the specified mode information occupies a field of seven bits in the open zone command.

In some implementations, the zone is a zone in a zone namespace (ZNS).

The description of the operation method example of the above ZUFS memory system is similar to the description of the above ZUFS memory system example, and has the beneficial effects similar to that of the ZUFS memory system example. Technical details not disclosed in the example method of operating the ZUFS memory system of the present disclosure should be understood referring to the description of the ZUFS memory system example of the present disclosure.

In the examples of the present disclosure, on the host side: by adding the specified mode information in the open zone command, the specified mode information may be set based on the actual demand, so that the storage mode of the to-be-created zone can be controlled. Correspondingly, on the ZUFS memory system side: a zone with a storage mode indicated by the specified mode information can be created based on the specified mode information in the open zone command. According to the examples of the present disclosure, the existing ZBC command can be utilized to create the zone with the specified storage mode.

In the examples of the present disclosure, on the host side: by adding the mode switching information in the reset write pointer command, the mode switching information may be set based on the actual demand, so that the storage mode of the specified zone may be controlled. Correspondingly, on the ZUFS memory system side: the storage mode of the specified zone can be switched to the storage mode indicated in the mode switching information based on the mode switching information in the reset write pointer command. According to the examples of the present disclosure, the existing ZBC command can be utilized to switch the specified zone between the first storage mode and the second storage mode.

In the examples of the present disclosure, when data writing is performed, a zone with the first storage mode may be selectively created or configured for the hot data based on the cold-hot attribute of the writing data, and a zone with the second storage mode may be created or configured for the non-hot data. In this way, the writing speed and the reading speed of the hot data can be improved.

The examples of the present disclosure further provide a computer-readable storage medium storing a computer program thereon, the computer program, when executed, implements the method of operating the memory system according to the examples of the present disclosure.

In some implementations, the computer-readable storage medium may be a ferromagnetic random access memory (FRAM), a read only memory (ROM), a programmable read-only memory (PROM), an erasable programmable read-only memory (EPROM), an electrically erasable programmable read-only memory (EEPROM), a flash memory, a magnetic surface memory, an optical disk, a compact disc read-only memory (CD-ROM), and the like; or may be various devices comprising one or any combination of the foregoing memories.

In some implementations, the computer program may be written in the form of a program, software, software module, script, or code, written in any form of programming language (comprising compiled or interpreted languages, or declarative or procedural languages), and deployed in any form, comprising being deployed as a standalone program or as a module, component, subroutine, or other unit suitable for use in a computing environment.

As an example, a computer program may, but is not necessarily, correspond to a file in a file system, may be stored in a portion of a file that saves other programs or data, for example, in one or more scripts in a hypertext markup language (HTML) document, in a single file dedicated to the program in question, or in multiple collaborative files (e.g., files storing one or more modules, subroutines, or portions of codes).

As an example, a computer program may be deployed for execution on one computing device, or on multiple computing devices located at one location, or alternatively on multiple computing devices distributed at multiple locations and interconnected over a communications network.

Reference throughout the description to “one example” or “an example” means that a particular feature, structure or characteristic related to the example is included in at least one example of the present disclosure. Thus, appearances of “in one example” or “in an example” in various places throughout the description are not necessarily referring to a same example. Furthermore, these particular features, structures or characteristics may be combined in any appropriate manner in one or more examples. In various examples of the present disclosure, sequence numbers of the processes described above do not mean the execution order, and the execution order of each process is to be determined by its function and internal logic, and should not constitute any limitation to implementation process of examples of the present disclosure. The serial numbers of examples of the present disclosure described above are for the purpose of description only, and do not represent the advantages and disadvantages of the examples.

The above description is only a preferred example of the present disclosure, and is not intended to limit the scope of the present disclosure, and any equivalent structural transformation made using the specification and drawings of the present disclosure, or direct/indirect application in other related technical fields under the inventive concept of the present disclosure is included within the scope of the present disclosure.

What is claimed is:

1. A zoned universal flash storage (ZUFS) memory system, comprising:
a memory device; and
a memory controller coupled with the memory device and configured to control the memory device to perform partition storage by zones, wherein a storage space of a zone is configured to support sequential writing,
wherein the memory controller is configured with a first interface for coupling with a host, and receives a first command from the host through the first interface, the first command comprises specified mode information, and the specified mode information indicates a storage mode of a to-be-created zone, and
the memory controller is further configured to:
determine whether available storage space of the memory device satisfies a creation condition according to the specified mode information; and
create a zone with the storage mode according to the first command in response to the available storage space satisfying the creation condition.

2. The ZUFS memory system of claim 1, wherein the memory controller is configured to:
set a state of the created zone to an open state; and
send creation success information to the host through the first interface.

3. The ZUFS memory system of claim 1, wherein the memory controller is configured to in response to the available storage space not satisfying the creation condition, send creation failure information to the host through the first interface.

4. The ZUFS memory system of claim 1, wherein the creation condition comprises that the available storage space of the memory device is greater than a storage space occupied by the to-be-created zone.

5. The ZUFS memory system of claim 1, wherein the memory controller is further configured to:
receive a zone writing request and writing data through the first interface; and
write the writing data into the created zone according to the zone writing request.

6. The ZUFS memory system of claim 1, wherein the storage mode comprises a first storage mode and a second storage mode, each of memory cells corresponding to the storage space of the zone configured with the first storage mode is capable of being written with N bits of data; each of the memory cells corresponding to the storage space of the zone configured with the second storage mode is capable of being written with M bits of data, M and N are integers greater than or equal to 1, and M is greater than N.

7. The ZUFS memory system of claim 6, wherein the memory controller is further configured to:
receive the zone writing request and writing data through the first interface, wherein the storage mode is the first storage mode responsive to the writing data being hot data, and the storage mode is the second storage mode responsive to the writing data being non-hot data; and
write the writing data into the zone created according to the first command according to the zone writing request.

8. The ZUFS memory system of claim 1, wherein the first command comprises an open zone command, and the specified mode information occupies a field of seven bits in the open zone command.

9. The ZUFS memory system of claim 1, wherein the zone is a zone in a zone namespace (ZNS).

10. A system, comprising:
a ZUFS memory system; and
a host, wherein:
the memory system comprises:
a memory device; and
a memory controller coupled with the memory device and configured to control the memory device to perform partition storage by zones, wherein a storage space of a zone is configured to support sequential writing;
the host comprises:
a host controller; and
a second interface, wherein the host controller is configured to generate a first command and send the first command to the memory controller through the second interface, wherein the first command comprises specified mode information for indicating a storage mode of a to-be-created zone; and
the memory controller is configured with a first interface for coupling with the second interface, and configured to:
receive a first command from the host through the first interface;
determine whether available storage space of the memory device satisfies a creation condition according to the specified mode information; and
create a zone with the storage mode according to the first command in response to the available storage space satisfying the creation condition.

11. The system of claim 10, wherein the memory controller is configured to:
set a state of the created zone to an open state; and
send creation success information to the host through the first interface.

12. The system of claim 10, wherein the memory controller is configured to in response to the available storage space not satisfying the creation condition, send creation failure information to the host through the first interface.

13. The system of claim 10, wherein the creation condition comprises that the available storage space of the memory device is greater than a storage space occupied by the to-be-created zone.

14. The system of claim 10, wherein the storage mode comprises a first storage mode and a second storage mode, each of memory cells corresponding to the storage space of the zone configured with the first storage mode is capable of being written with N bits of data, each of the memory cells corresponding to the storage space of the zone configured with the second storage mode is capable of being written with M bits of data, M and N are integers greater than or equal to 1, and M is greater than N.

15. The system of claim 14, wherein the host controller is configured to generate a corresponding first command according to a cold-hot attribute of writing data, wherein the storage mode in the first command is the first storage mode responsive to the writing data being hot data, and wherein the storage mode in the first command is the second storage mode responsive to the writing data being non-hot data.

16. The system of claim 15, wherein the host controller is configured to:
generate a zone writing request corresponding to the writing data; and
send the writing data and the zone writing request to the memory controller through the second interface; and
the memory controller is further configured to:
receive the zone writing request and the writing data through the first interface; and
write the writing data into the zone created according to the first command according to the zone writing request.

17. The system of claim 10, wherein the first command comprises an open zone command, and the specified mode information occupies a field of seven bits in the open zone command.

18. The system of claim 10, wherein the zone is a zone in a zone namespace (ZNS).

19. A method of operating a ZUFS memory system, wherein the ZUFS memory system comprises a memory device and a memory controller coupled with the memory device and configured with a first interface for coupling with a host, the method comprising:
receiving a first command through the first interface, wherein the first command comprises specified mode information for indicating a storage mode of a to-be-created zone, the zone corresponds to a storage space of the memory device, and the storage space of the zone is configured to support sequential writing;
determining whether available storage space of the memory device satisfies a creation condition according to the specified mode information; and
creating the zone with the storage mode according to the first command in response to the available storage space satisfying the creation condition.

20. The method of claim 19, further comprising:
setting a state of the created zone to an open state; and
sending creation success information to the host through the first interface.
